(19) United States
(12) Patent Application Publication
(10) Pub. No.: US 2024/0224115 A1
(43) Pub. Date: Jul. 4, 2024

(54) PACKET LOSS DATA ERROR CORRECTION METHOD AND APPARATUS IN DUAL-TRANSMIT MODE, DEVICE, AND SYSTEM

(71) Applicant: ZHUHAI JIELI TECHNOLOGY CO., LTD, Zhuhai (CN)

(72) Inventors: Ziming Huang, Zhuhai (CN); Haitao Huang, Zhuhai (CN); Qiming Zhang, Zhuhai (CN); Xiangjun Hu, Zhuhai (CN); Guangjun Luo, Zhuhai (CN); Jiajun Zhu, Zhuhai (CN)

(21) Appl. No.: 18/608,963

(22) Filed: Mar. 19, 2024

Related U.S. Application Data
(63) Continuation of application No. PCT/CN2021/132494, filed on Nov. 23, 2021.

(30) Foreign Application Priority Data
Jul. 22, 2021 (CN) 202110830805.9

(51) Int. Cl. H04W 28/04; H04L 1/1607; H04W 28/02

(52) U.S. Cl. CPC H04W 28/04; H04L 1/1607; H04W 28/0236

(57) ABSTRACT

This application discloses a packet loss data error correction method and apparatus in dual-transmit mode, a device, and a system. The method includes: step S100: driving a first Bluetooth playing device to establish an information exchange link with a second Bluetooth playing device; step S200: controlling the first Bluetooth playing device to exchange link information with the second Bluetooth playing device; step S300: controlling the first Bluetooth playing device to receive first current audio data that is sent to the first Bluetooth playing device by an audio source device; step S400: sending a first forwarding request to the second Bluetooth playing device a preset time interval after a local link subevent anchor; and step S500: receiving the first current audio data that is forwarded by the second Bluetooth playing device. It can improve communication quality of dual Bluetooth playing devices.

### CROSS REFERENCE TO RELATED APPLICATIONS

The present application is a Continuation application of PCT Application No. PCT/CN2021/132494 filed on Nov. 23, 2021, which claims the benefit of Chinese Patent Application No. 202110830805.9 filed on Jul. 22, 2021. All the above are hereby incorporated by reference in their entirety.

### TECHNICAL FIELD

This application relates to the field of Bluetooth audio communication technologies, and in particular, to a packet loss data error correction method and apparatus in dual-transmit mode, a device, and a system.

### BACKGROUND

The Bluetooth Special Interest Group has added Bluetooth Low Energy (BLE) audio support (LE audio) to the Bluetooth protocol version 5.2. For applications of dual-wireless audio communication, for example, scenarios such as dual-wireless Bluetooth earphones and dual-wireless Bluetooth speakers, according to descriptions in the Bluetooth Low Energy protocol, an audio source device performs dual transmission for implementation, and only single-channel audio data belonging to its playing device is transmitted over each link. Therefore, there is inevitably a problem that a distance of dual-wireless audio communication decreases due to environmental changes, human interference, and the like. As a result, communication provided by a standard Bluetooth network does not meet application requirements of dual-wireless audio.

FIG. 1 is a schematic diagram of a structure of a dual-wireless audio network implemented in dual-transmit mode in the conventional technology. For dual-wireless audio implemented through dual transmission performed by an audio source device, three Bluetooth devices are included: one Bluetooth audio source device (Source, for example, a mobile phone or a notebook computer), and two Bluetooth devices that play simultaneously (TWS Sink1 and TWS Sink2, for example, Bluetooth dual earphones and Bluetooth dual speakers). Being implemented in a mode different from a receiving/listening mode in a conventional Bluetooth protocol, dual-wireless audio applications in dual-transmit mode described in the BLE protocol comply with the standard Bluetooth Low Energy protocol. The Bluetooth audio source device (source) establishes synchronous links (links CIS1 and CIS2) for audio communication with the two Bluetooth playing devices, respectively, for exchange of audio data. The two Bluetooth playing devices are not connected and are not aware of existence of each other. In addition, an audio bit rate is reduced using means such as optimizing a codec of audio, and transmitting only single-channel audio data that belongs to its playing device over each link. Compared with existing manners in which dual-wireless audio is built with Bluetooth Classic, this manner has an advantage of lower power consumption, but completely depends on quality of communication between the Bluetooth audio source device and each Bluetooth playing device. Therefore, it is more likely restricted by factors such as environmental changes and human interference, resulting in a problem that a distance of dual-wireless audio communication is short, and affecting user experience.

Existing dual-wireless Bluetooth audio devices are usually developed with changes made to the Bluetooth Classic protocol to obtain a new manner of audio communication, so as to meet requirements of dual-wireless audio communication. Currently, several methods used on Bluetooth Classic include a pure listening manner, a pure forwarding manner, a dual-transmit manner, and a listening and forwarding manner. The Bluetooth Special Interest Group has added audio functionality to the BLE section of the Bluetooth protocol 5.2, and adopts a dual-transmit manner for transmission of dual-wireless audio.

In the pure listening manner used on Bluetooth Classic, a Bluetooth audio source device connects to only one of two Bluetooth playing devices, and the Bluetooth playing device notifies the other Bluetooth playing device of information about a connection to the Bluetooth audio source device after being connected to the other Bluetooth playing device, so that the other Bluetooth playing device can listen to audio data from the Bluetooth audio source device based on the information and play the audio data synchronously, implementing dual-wireless Bluetooth audio functionality.

In the pure forwarding manner used on Bluetooth Classic, a Bluetooth audio source device connects to only one of two Bluetooth playing devices, and the Bluetooth playing device directly forwards audio data from the Bluetooth audio source device to the other Bluetooth playing device for synchronous playing after being connected to the other Bluetooth playing device, implementing dual-wireless Bluetooth audio functionality.

In the dual-transmit manner used on Bluetooth Classic, a Bluetooth audio source device connects to two Bluetooth playing devices separately, and transmits audio data to each Bluetooth playing device separately for synchronous playing, implementing dual-wireless Bluetooth audio functionality. This manner requires the Bluetooth audio source device to support dual-transmit functionality, hindering mass promotion and affecting competitiveness of products.

In the listening and forwarding manner used on Bluetooth Classic, the pure listening manner and the pure forwarding manner are integrated, so that reliability of communication can be optimized using the forwarding manner when communication over a listened-on link deteriorates, improving application scenarios of dual-wireless Bluetooth audio.

A wireless audio communication method used on BLE is similar to the dual-transmit manner used on Bluetooth Classic, as shown in FIG. 1. However, in BLE, by using means such as optimizing a codec of audio, and transmitting only single-channel audio data that belongs to its playing device over each link, an audio bit rate is reduced, and communication bandwidths are increased, thereby reducing overall power consumption. In addition, device use behavior is regulated from a perspective of the standard protocol. Therefore, the wireless audio communication method used on BLE can be promoted more widely in the future than the proprietary dual-transmit manner used on Bluetooth Classic, improving competitiveness of products.

For the dual-wireless audio applications in dual-transmit mode described in the BLE protocol, in standard Bluetooth Low Energy protocol specifications, communication over the CIS1 or the CIS2 may be interfered with by factors such as environmental changes and human interference, for example, a position of a person's head in the dual-wireless audio communication network. Consequently, performance of the TWS Sink1 or the TWS Sink2 in receiving audio data deteriorates, resulting in a problem that dual-wireless audio communication encounters distance decreasing or stuttering, and affecting user experience.

Therefore, how impact of poor data reception performance that is due to interference caused by factors such as environments and human bodies to links is reduced in a case of the dual-transmit mode becomes an urgent technical problem to be resolved.

### SUMMARY

Based on the foregoing situation, the present invention mainly aims to provide a packet loss data error correction method and apparatus in dual-transmit mode, a device, and a system, to reduce, in a case of dual-transmit mode, impact of poor data reception performance that is due to interference caused by factors such as environments and human bodies to links.

To achieve the foregoing objective, technical solutions described in the present invention are as follows.

According to a first aspect, an embodiment of the present invention discloses a packet loss data error correction method in dual-transmit mode, used for controlling data exchange between a first Bluetooth playing device and a second Bluetooth playing device. The first Bluetooth playing device, the second Bluetooth playing device, and an audio source device constitute a Bluetooth communication network in dual-transmit mode. The audio source device establishes a first communication link with the first Bluetooth playing device, and the audio source device establishes a second communication link with the second Bluetooth playing device, so that the audio source device performs audio data communication with the first Bluetooth playing device and the second Bluetooth playing device separately. The packet loss data error correction method includes:
step S100: driving the first Bluetooth playing device to establish an information exchange link with the second Bluetooth playing device, where the first Bluetooth playing device and the second Bluetooth playing device exchange communication information over the information exchange link;
step S200: controlling the first Bluetooth playing device to exchange link information with the second Bluetooth playing device over the information exchange link, so that the first Bluetooth playing device configures itself to listen on the second communication link based on link information provided by the second Bluetooth playing device, and the second Bluetooth playing device configures itself to listen on the first communication link based on link information provided by the first Bluetooth playing device;
step S300: controlling, at a local link subevent anchor, the first Bluetooth playing device to receive first current audio data that is sent to the first Bluetooth playing device by the audio source device, where during the period, the second Bluetooth playing device listens to the first current audio data, and the local link subevent anchor is a time point at which the audio source device sends audio data to the first Bluetooth playing device over the first communication link;
step S400: when the first current audio data is not received at the local link subevent anchor, controlling the first Bluetooth playing device to send, a preset time interval after the local link subevent anchor, a first forwarding request to the second Bluetooth playing device over the information exchange link, so that the second Bluetooth playing device forwards the first current audio data; and
step S500: controlling, at the arrival of an agreed anchor, the first Bluetooth playing device to receive the first current audio data that is forwarded by the second Bluetooth playing device based on the first forwarding request.

Optionally, the method further includes:
step S320: controlling, at a listened-on link subevent anchor, the first Bluetooth playing device to listen to second current audio data that is sent to the second Bluetooth playing device by the audio source device, where the listened-on link subevent anchor is a time point at which the audio source device sends audio data to the second Bluetooth playing device over the second communication link; and
step S420: controlling, a preset time interval after the listened-on link subevent anchor, the first Bluetooth playing device to open a receiving window for receiving a forwarding request, to receive, over the information exchange link, a second forwarding request that is sent by the second Bluetooth playing device, and forward the second current audio data to the second Bluetooth playing device based on the second forwarding request.

Optionally, in step S420, when the second forwarding request is received during the receiving window, the method further includes:
at the arrival of an agreed anchor, latching the first Bluetooth playing device into a forwarding state, and forwarding the second current audio data.

Optionally, in step S420, when the second forwarding request is not received during the receiving window, the method further includes:
controlling the first Bluetooth playing device to return to perform step S300 or step S320.

Optionally, the preset time interval is a sum of maximum duration of audio data currently sent by the audio source device and an interframe space between adjacent packets.

According to a second aspect, an embodiment of the present invention discloses a packet loss data error correction apparatus in dual-transmit mode, configured to control data exchange between a first Bluetooth playing device and a second Bluetooth playing device. The first Bluetooth playing device, the second Bluetooth playing device, and an audio source device constitute a Bluetooth communication network in dual-transmit mode. The audio source device establishes a first communication link with the first Bluetooth playing device, and the audio source device establishes a second communication link with the second Bluetooth playing device, so that the audio source device performs audio data communication with the first Bluetooth playing device and the second Bluetooth playing device separately. The packet loss data error correction apparatus includes:
an information exchange link establishment module, configured to drive the first Bluetooth playing device to establish an information exchange link with the second Bluetooth playing device, where the first Bluetooth playing device and the second Bluetooth playing device exchange communication information over the information exchange link;
a link information exchange module, configured to control the first Bluetooth playing device to exchange link information with the second Bluetooth playing device over the information exchange link, so that the first Bluetooth playing device configures itself to listen on the second communication link based on link information provided by the second Bluetooth playing device, and the second Bluetooth playing device configures itself to listen on the first communication link based on link information provided by the first Bluetooth playing device;
a first receiving module, configured to control, at a local link subevent anchor, the first Bluetooth playing device to receive first current audio data that is sent to the first Bluetooth playing device by the audio source device, where during the period, the second Bluetooth playing device listens to the first current audio data, and the local link subevent anchor is a time point at which the audio source device sends audio data to the first Bluetooth playing device over the first communication link;
a request sending module, configured to: when the first current audio data is not received at the local link subevent anchor, control the first Bluetooth playing device to send, a preset time interval after the local link subevent anchor, a first forwarding request to the second Bluetooth playing device over the information exchange link, so that the second Bluetooth playing device forwards the first current audio data; and
a second receiving module, configured to control, at the arrival of an agreed anchor, the first Bluetooth playing device to receive the first current audio data that is forwarded by the second Bluetooth playing device based on the first forwarding request.

Optionally, the apparatus further includes:
a listening module, configured to control, at a listened-on link subevent anchor, the first Bluetooth playing device to listen to second current audio data that is sent to the second Bluetooth playing device by the audio source device, where the listened-on link subevent anchor is a time point at which the audio source device sends audio data to the second Bluetooth playing device over the second communication link; and
a window opening module, configured to control, a preset time interval after the listened-on link subevent anchor, the first Bluetooth playing device to open a receiving window for receiving a forwarding request, to receive, over the information exchange link, a second forwarding request that is sent by the second Bluetooth playing device, and forward the second current audio data to the second Bluetooth playing device based on the second forwarding request.

Optionally, in the window opening module, when the second forwarding request is received during the receiving window, the following is further included:
at the arrival of an agreed anchor, latching the first Bluetooth playing device into a forwarding state, and forwarding the second current audio data.

Optionally, in the window opening module, when the second forwarding request is not received during the receiving window, the following is further included:
controlling the first Bluetooth playing device to return to run the first receiving module or the listening module.

Optionally, the preset time interval is a sum of maximum duration of audio data currently sent by the audio source device and an interframe space between adjacent packets.

According to a third aspect, an embodiment of the present invention discloses a Bluetooth playing device, including:
a processor, configured to implement the method disclosed in the first aspect.

According to a fourth aspect, an embodiment of the present invention discloses an audio signal processing system, including a first Bluetooth playing device and a second Bluetooth playing device. The first Bluetooth playing device and the second Bluetooth playing device are an audio playing device pair;
the first Bluetooth playing device has the apparatus disclosed in the second aspect; and
the second Bluetooth playing device has the apparatus disclosed in the second aspect.

Optionally, the system further includes:
an audio source device, configured to provide audio data to the first Bluetooth playing device and the second Bluetooth playing device.

According to a fifth aspect, an embodiment of the present invention discloses a computer-readable storage medium. A computer program is stored in the computer-readable storage medium. The computer program stored in the storage medium is executed to implement the method disclosed in the first aspect.

According to a sixth aspect, an embodiment of the present invention discloses a chip for an audio device. An integrated circuit is provided on the chip. The integrated circuit is designed to implement the method disclosed in the first aspect.

### Beneficial Effects

According to the packet loss data error correction method and apparatus in dual-transmit mode, the device, and the system disclosed in the embodiments of the present invention, the first Bluetooth playing device exchanges link information with the second Bluetooth playing device over the information exchange link, so that the first Bluetooth playing device configures itself to listen on the second communication link based on link information provided by the second Bluetooth playing device, and the second Bluetooth playing device configures itself to listen on the first communication link based on link information provided by the first Bluetooth playing device. In this way, in dual-transmit mode, the first Bluetooth playing device and the second Bluetooth playing device can listen to audio data of each other. At the local link subevent anchor, the first Bluetooth playing device receives the first current audio data that is sent to the first Bluetooth playing device by the audio source device, where during the period, the second Bluetooth playing device listens to the first current audio data. In this way, the second Bluetooth playing device can also receive the audio data that is sent to the first Bluetooth playing device by the audio source device. When the first current audio data is not received at the local link subevent anchor, the first Bluetooth playing device sends the first forwarding request to the second Bluetooth playing device over the information exchange link the preset time interval after the local link subevent anchor. At the arrival of the agreed anchor, the first Bluetooth playing device receives the first current audio data that is forwarded by the second Bluetooth playing device based on the first forwarding request. In the embodiments of the present invention, in dual-transmit mode, when the first current audio data is not received, the first forwarding request is sent to the second Bluetooth playing device, and the first current audio data that is forwarded by the second Bluetooth playing device based on the first forwarding request is received. In this way, in dual-transmit mode, when data reception performance of the link of the first Bluetooth playing device deteriorates due to interference caused by factors such as environments and human bodies, the first current audio data can be forwarded by the second Bluetooth playing device. Because the first Bluetooth playing device and the second Bluetooth playing device are in different positions in space, a good space diversity gain can be obtained, reducing impact of poor signal quality that is caused by factors such as environments and human bodies. A manner of forwarding from another link is used to avoid a communication problem that is caused after a single link is interfered with, improving communication quality of dual Bluetooth playing devices.

Other beneficial effects of the present invention are elaborated on in the detailed description through description of specific technical features and technical solutions. With descriptions of the technical features and technical solutions, persons skilled in the art should be able to understand beneficial technical effects brought by the technical features and technical solutions.

### BRIEF DESCRIPTION OF THE DRAWINGS

The following describes embodiments of the present invention with reference to the accompanying drawings. Of the drawings:

FIG. 1 is a schematic diagram of a structure of a dual-wireless audio network implemented in dual-transmit mode in the conventional technology;

FIG. 2 is a schematic diagram of a structure of a Bluetooth communication network in dual-transmit mode disclosed in an embodiment;

FIG. 3 is a flowchart of a packet loss data error correction method in dual-transmit mode disclosed in an embodiment;

FIG. 4 is a schematic diagram of communication timing of a Bluetooth communication network in dual-transmit mode disclosed in an embodiment; and

FIG. 5 is a schematic diagram of a structure of a packet loss data error correction apparatus in dual-transmit mode disclosed in an embodiment.

### DETAILED DESCRIPTION

The following describes this application based on embodiments, but this application is not limited merely to these embodiments. In descriptions of details of this application below, some specific details are described in detail. To avoid confusion about essence of this application, well-known methods, processes, procedures, and components are not described in detail.

In addition, persons of ordinary skill in the art should understand that the accompanying drawings provided herein are all for illustrative purposes and are not necessarily drawn to scale.

Unless explicitly indicated in the context, “include”, “comprise”, and similar words throughout the specification and claims should be interpreted as inclusive rather than exclusive or exhaustive, that is, as “including but not limited to”.

In descriptions of this application, it should be understood that terms such as “first” and “second” are used for descriptive purposes only, and shall not be understood as an indication or implication of relative importance. In addition, in the descriptions of this application, “a plurality of” means two or more unless otherwise specified.

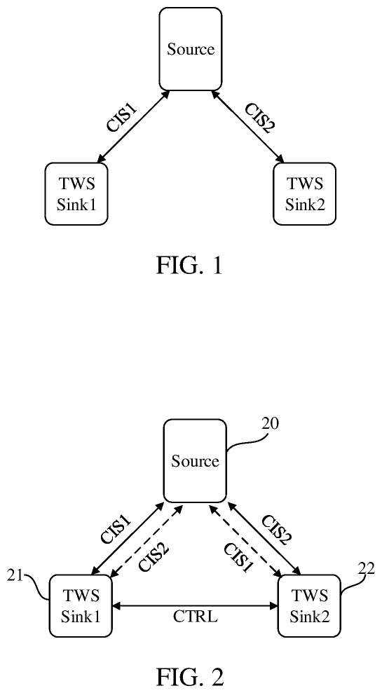

To reduce, in a case of dual-transmit mode, impact of poor data reception performance that is due to interference caused by factors such as environments and human bodies to links, an embodiment discloses a packet loss data error correction method in dual-transmit mode. FIG. 2 is a schematic diagram of a structure of a Bluetooth communication network in dual-transmit mode disclosed in an embodiment. A first Bluetooth playing device 21, a second Bluetooth playing device 22, and an audio source device 20 constitute a Bluetooth communication network in dual-transmit mode. The audio source device 20 establishes a first communication link CIS1 with the first Bluetooth playing device 21, and the audio source device 20 establishes a second communication link CIS2 with the second Bluetooth playing device 22, so that the audio source device 20 performs audio data communication with the first Bluetooth playing device 21 and the second Bluetooth playing device 22 separately. Specifically, the audio source device 20 provides the first Bluetooth playing device 21 and the second Bluetooth playing device 22 with their respective audio data at different time points.

In this embodiment, an example is used for description in which the first Bluetooth playing device 21 and the second Bluetooth playing device 22 are Bluetooth earphones. During specific implementation, the first Bluetooth playing device 21 and the second Bluetooth playing device 22 may alternatively be devices with Bluetooth and audio playing functions such as Bluetooth speakers.

It should be noted that the first Bluetooth playing device 21 and the second Bluetooth playing device 22 are paired playing devices. Therefore, roles of the first Bluetooth playing device 21 and the second Bluetooth playing device 22 can be interchanged, that is, “first” and “second” are used merely for distinguishing between two Bluetooth playing devices. For example, when the first Bluetooth playing device 21 is a left earphone, the second Bluetooth playing device 22 is a right earphone; or when the first Bluetooth playing device 21 is a right earphone, the second Bluetooth playing device 22 is a left earphone.

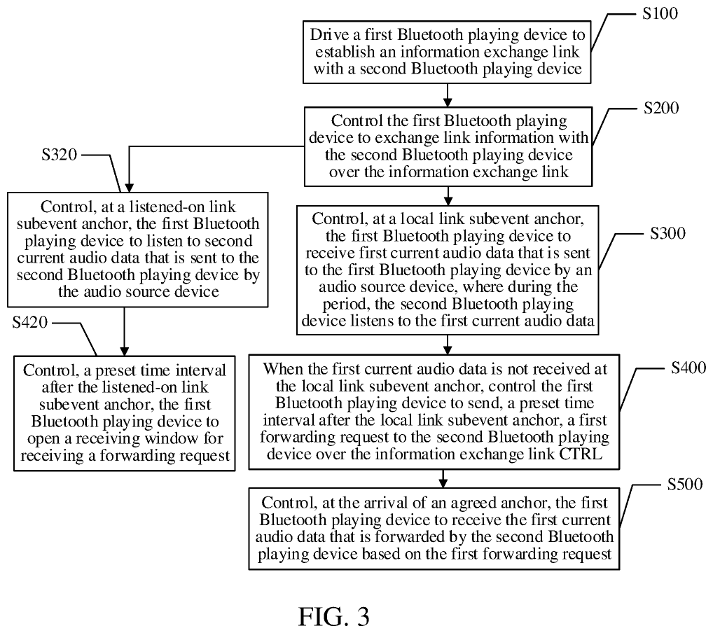

FIG. 3 is a flowchart of a packet loss data error correction method in dual-transmit mode disclosed in an embodiment. The method is used for controlling data exchange between a first Bluetooth playing device 21 and a second Bluetooth playing device 22. The packet loss data error correction method includes step S100, step S200, step S300, step S400, and step S500.

Step S100: Drive the first Bluetooth playing device to establish an information exchange link CTRL with the second Bluetooth playing device. With reference to FIG. 1 and FIG. 2, in this embodiment, on the basis of the structure of the dual-wireless audio network in conventional dual-transmit mode shown in FIG. 1, the information exchange link CTRL is established between the first Bluetooth playing device 21 and the second Bluetooth playing device 22. The first Bluetooth playing device 21 and the second Bluetooth playing device 22 exchange communication information over the information exchange link CTRL. In this embodiment, the first Bluetooth playing device 21 and the second Bluetooth playing device 22 may further forward, over the information exchange link CTRL, audio data received by each other.

Step S200: Control the first Bluetooth playing device to exchange link information with the second Bluetooth playing device over the information exchange link. With reference to FIG. 2, after the first Bluetooth playing device 21 establishes the information exchange link CTRL with the second Bluetooth playing device 22, the first Bluetooth playing device 21 and the second Bluetooth playing device 22 can exchange link information over the information exchange link CTRL. In this way, the first Bluetooth playing device 21 can configure itself to listen on the second communication link CIS2 based on link information provided by the second Bluetooth playing device 22, and the second Bluetooth playing device 22 can configure itself to listen on the first communication link CIS1 based on link information provided by the first Bluetooth playing device 21. As such, the first Bluetooth playing device 21 and the second Bluetooth playing device 22 listen to audio data of each other, and can forward the audio data of each other over the information exchange link CTRL, implementing a structure of a dual-wireless Bluetooth audio network that is implemented in a dual-transmit, listening and forwarding manner described in the BLE protocol.

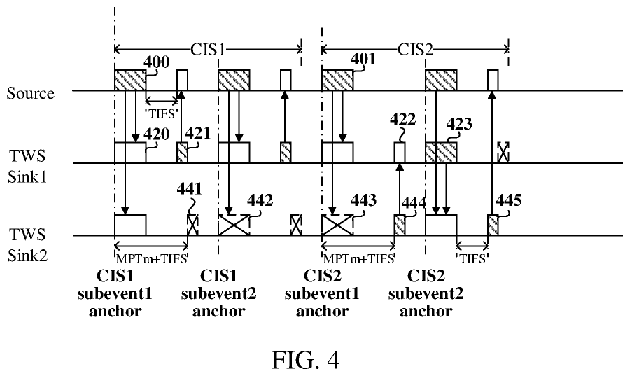

Step S300: Control, at a local link subevent anchor (or anchor point), the first Bluetooth playing device to receive first current audio data that is sent to the first Bluetooth playing device by the audio source device, where during the period, the second Bluetooth playing device listens to the first current audio data. In this embodiment, the Bluetooth communication network in dual-transmit mode includes local link subevent anchors and listened-on link subevent anchors. With reference to FIG. 2, when the TWS Sink1 is the first Bluetooth playing device 21 and the TWS Sink2 is the second Bluetooth playing device 22, the local link subevent anchor is a time point at which the audio source device 20 sends audio data to the first Bluetooth playing device 21 over the first communication link CIS1 (as indicated by a solid line marking the CIS1 in FIG. 2), and the listened-on link subevent anchor is a time point at which the audio source device 20 sends audio data to the second Bluetooth playing device 22 over the second communication link CIS2 (as indicated by a solid line marking the CIS2 in FIG. 2). FIG. 4 is a schematic diagram of communication timing of a Bluetooth communication network in dual-transmit mode disclosed in an embodiment. With reference to FIG. 4, “CIS1 subevent1 anchor” and “CIS1 subevent2 anchor” represent two local link subevent anchors of the first Bluetooth playing device 21 (for example, the TWS Sink1), and are listened-on link subevent anchors for the second Bluetooth playing device 22 in this case; and “CIS2 subevent1 anchor” and “CIS2 subevent2 anchor” represent two local link subevent anchors of the second Bluetooth playing device 22 (for example, the TWS Sink2), and are listened-on link subevent anchors for the first Bluetooth playing device 21 in this case.

With reference to FIG. 2 and FIG. 4, for the first Bluetooth playing device 21 (for example, the TWS Sink1), at the local link subevent anchor, the audio source device 20 sends audio data 400 to the first Bluetooth playing device 21 (for example, the TWS Sink1) over the first communication link CIS1, and at this time, the second Bluetooth playing device 22 (for example, the TWS Sink2) listens to the audio data 400; and for the second Bluetooth playing device 22, at the local link subevent anchor, the audio source device 20 sends audio data 401 to the second Bluetooth playing device 22 (for example, the TWS Sink2) over the second communication link CIS2, and at this time, the first Bluetooth playing device 21 (for example, the TWS Sink1) listens to the audio data 401.

Step S400: When the first current audio data is not received at the local link subevent anchor, control the first Bluetooth playing device to send, a preset time interval after the local link subevent anchor, a first forwarding request to the second Bluetooth playing device over the information exchange link CTRL. With reference to FIG. 4, for example, the TWS Sink2 is a local device. To be specific, the audio source device 20 (Source) sends the audio data 401 to the TWS Sink2 over the link CIS2, and the TWS Sink1 listens to the audio data 401 sent by the audio source device (Source) 20. Due to interference caused by an environmental change, a human body, or the like, reception performance of the device TWS Sink2 deteriorates and cannot receive the audio data from the local link CIS. For example, the device TWS Sink2 cannot receive the audio data 401 (as indicated by a mark 443) from the local link CIS2 at a position of the CIS2 subevent1 anchor. In this case, the first Bluetooth playing device 21 (for example, the TWS Sink2) sends a first forwarding request Rreq to the second Bluetooth playing device 22 (for example, the TWS Sink1) a preset time interval after the local link subevent anchor, so that the second Bluetooth playing device forwards the first current audio data.

In an optional embodiment, the preset time interval is a sum of maximum duration MPTm of audio data currently sent by the audio source device and an interframe space TIFS between adjacent packets. To be specific, the first Bluetooth playing device (for example, the TWS Sink2) sends the first forwarding request Rreq MPTm+TIFS after the local link subevent anchor. MPTm is converted from duration of a longest audio packet sent by the audio source device. Specifically, the duration of the longest audio packet can be obtained based on information of a header of the audio packet. The interframe space between adjacent packets is a time interval from the end of a previous packet to the start of a packet following the previous packet. TIFS is an interframe space of 150 ρs stipulated in the Bluetooth protocol. In this embodiment, the maximum duration MPTm is added to the interframe space TIFS between adjacent packets to form the preset time interval, avoiding that there is no space for an additional packet due to an excessively long packet.

Step S500: Control, at the arrival of an agreed anchor, the first Bluetooth playing device to receive the first current audio data that is forwarded by the second Bluetooth playing device based on the first forwarding request. With reference to FIG. 4, after receiving the first forwarding request Rreq, the second Bluetooth playing device 22 (for example, the TWS Sink1) forwards a corresponding packet 423 at a next listened-on link subevent anchor; and at the next listened-on link subevent anchor, the first Bluetooth playing device 21 (for example, the TWS Sink2) is ready to receive the corresponding packet 423 that is forwarded by the second Bluetooth playing device 22 (for example, the TWS Sink1).

In an optional embodiment, preferably, the first communication link CIS1, the second communication link CIS2, and the information exchange link CTRL operate in a same frequency band.

According to the standard protocol, the first Bluetooth playing device does not send an ACK response to the audio source device if failing to receive the audio data. Therefore, based on that no ACK response is received, the audio source device retransmits the first current audio data. For example, at a position of the CIS2 subevent2 anchor in FIG. 4, the audio source device 20 (Source) also retransmits the corresponding first current audio data while the second Bluetooth playing device 22 (for example, the TWS Sink1) forwards the corresponding packet 423.

Therefore, the first Bluetooth playing device 21 can simultaneously receive the first current audio data forwarded by the second Bluetooth playing device 22 and the first current audio data retransmitted by the audio source device 20. In other words, the first Bluetooth playing device 21 can receive the retransmitted/forwarded first current audio data from two devices. In this way, a probability that data reception fails again because a single link is interfered with is reduced, and a success rate of receiving the first current audio data is further increased.

To improve communication quality of the second Bluetooth playing device, in an optional embodiment, with reference to FIG. 3, the packet loss data error correction method in dual-transmit mode further includes the following steps.

Step S320: Control, at a listened-on link subevent anchor, the first Bluetooth playing device to listen to second current audio data that is sent to the second Bluetooth playing device by the audio source device. With reference to FIG. 4, at the arrival of a listened-on link subevent anchor (CIS1 subevent1 anchor), the audio source device 20 (Source) sends second current audio data (as indicated by a mark 400) to the second Bluetooth playing device 22 (for example, the TWS Sink1). During the period, the first Bluetooth playing device 21 (for example, the TWS Sink2) listens to the second current audio data.

Step S420: Control, a preset time interval after the listened-on link subevent anchor, the first Bluetooth playing device to open a receiving window for receiving a forwarding request. With reference to FIG. 4, a receiving window (as indicated by a mark 441) for receiving a forwarding request is opened a preset time interval after the listened-on link subevent anchor (CIS1 subevent1 anchor). In this way, when the second Bluetooth playing device 22 (for example, the TWS Sink1) does not receive the second current audio data, the second Bluetooth playing device 22 (for example, the TWS Sink1) can send a second forwarding request to the receiving window of the first Bluetooth playing device 21 (for example, the TWS Sink2) over the information exchange link CTRL. The first Bluetooth playing device 21 can receive, over the information exchange link CTRL, the second forwarding request sent by the second Bluetooth playing device, to forward the second current audio data to the second Bluetooth playing device based on the second forwarding request. Specifically, when the second forwarding request is received during the receiving window (as indicated by the mark 441), the second current audio data is forwarded to the second Bluetooth playing device 22 (for example, the TWS Sink1) at the arrival of an agreed anchor. On the contrary, when the second forwarding request is not received during the receiving window (as indicated by the mark 441), the second current audio data does not need to be forwarded.

In an optional embodiment, in step S420, when the second forwarding request is received during the receiving window, the method further includes: at the arrival of the agreed anchor, latching the first Bluetooth playing device into a forwarding state, and forwarding the second current audio data. In step S420, when the second forwarding request is not received during the receiving window, the method further includes: controlling the first Bluetooth playing device to return to perform step S300 or step S320.

Specifically, after receiving a forwarding request Rreq from the second Bluetooth playing device 22, the first Bluetooth playing device 21 (as a listening device of the second Bluetooth playing device 22) is latched into the forwarding state for forwarding a corresponding packet in a next listened-on link subevent. A forwarding state latching flag is used for determining whether receiving/listening to audio packets from a link continues or forwarding a previous audio packet is performed at an agreed anchor. If the latched forwarding state is forwarding, the first Bluetooth playing device 21 (as a listening device of the second Bluetooth playing device 22) performs forwarding at the agreed anchor, or otherwise, performs receiving/listening.

As shown in FIG. 4, the forwarding state is latched at a position of a mark 422 based on information included in a forwarding request 444. Then, an audio packet is forwarded at a position of a next listening anchor 423. At a position of a mark 441, no forwarding request is received. Then, listening to next audio data continues at a position of a next listening anchor 442.

To help persons skilled in the art understand the foregoing information, the following describes FIG. 4 from perspectives of two cases.

Case 1: A current time point is a local link subevent anchor.

As shown in FIG. 2 and FIG. 4, a local link of the device TWS Sink1 is the link CIS1, and a local link of the device TWS Sink2 is the link CIS2. Therefore, when a time point of the device TWS Sink1 reaches the CIS1 subevent1 anchor (subevent anchor) or when a time point of the device TWS Sink2 reaches the CIS2 subevent1 anchor (subevent anchor), the device Source sends an audio packet 400 to the device TWS Sink1 or an audio packet 401 to the device TWS Sink2. The device TWS Sink1 starts to receive the audio data 400 from the local link at the CIS1 subevent anchor, and the device TWS Sink2 starts to receive the audio data 401 from the local link at the CIS2 subevent anchor.

Due to interference caused by an environmental change, a human body, or the like, reception performance of a TWS device deteriorates and cannot receive audio data from a local link. For example, the device TWS Sink2 cannot receive the audio data 401 (indicated by the mark 443 in FIG. 4) from the local link at a position of the CIS2 subevent1 anchor. In this case, the device TWS Sink2 sends a forwarding request Rreq (indicated by the mark 444 in FIG. 4) to the device TWS Sink1 MPTm+TIFS after the CIS2 subevent1 anchor.

Case 2: A current time point is a listened-on link subevent anchor.

A TWS device determines whether a current time point is a listened-on link CIS subevent anchor. For example, the device TWS Sink1 determines whether a current time point is at a position of a link CIS2 subevent anchor, or the device TWS Sink2 determines whether a current time point is at a position of a link CIS1 subevent anchor.

As shown in FIG. 4, a listened-on link of the device TWS Sink1 is the link CIS2, and a listened-on link of the device TWS Sink2 is the link CIS1. Therefore, when a time point of the device TWS Sink1 reaches the CIS2 subevent1 anchor (subevent anchor) or when a time point of the device TWS Sink2 reaches the CIS1 subevent1 anchor (subevent anchor), the device TWS Sink1 listens to an audio packet 401 sent by the device Source, or the device TWS Sink2 listens to an audio packet 400 sent by the device Source.

The device TWS Sink1 starts to receive to the audio data 401 from the listened-on link CIS at the CIS2 subevent anchor, and the device TWS Sink2 starts to receive the audio data 400 from the listened-on link CIS at the CIS1 subevent anchor.

If obtaining an audio packet through listening, a TWS device opens, MPTm+TIFS after a listened-on link subevent anchor, a receiving window to receive a forwarding request, as indicated by the mark 441 for the TWS Sink2 that serves as a listening device of the TWS Sink1, and as indicated by the mark 422 for the TWS Sink1 that serves as a listening device of the TWS Sink2 in FIG. 4.

If no forwarding request packet is received at the position, for example, if the TWS Sink2 that serves as a listening device of the TWS Sink1 does not receive a forwarding request at the mark 441, the listening device TWS Sink2 decides to continue listening to, at a position of a next listened-on link anchor (for example, a position indicated by the mark 442), audio source data that is sent to the TWS Sink1 by the audio device.

If a forwarding request packet is received at the position, for example, if the TWS Sink1 that serves as a listening device of the TWS Sink2 receives a forwarding request 444 at the mark 422, the listening device TWS Sink1 determines, based on information included in the forwarding request packet, whether a corresponding audio packet is obtained through listening, and decides to forward corresponding audio data 423 at a position of a next listened-on link anchor.

An embodiment further discloses a packet loss data error correction apparatus in dual-transmit mode, configured to control data exchange between a first Bluetooth playing device and a second Bluetooth playing device. The first Bluetooth playing device, the second Bluetooth playing device, and an audio source device constitute a Bluetooth communication network in dual-transmit mode. The audio source device establishes a first communication link CIS1 with the first Bluetooth playing device, and the audio source device establishes a second communication link CIS2 with the second Bluetooth playing device, so that the audio source device performs audio data communication with the first Bluetooth playing device and the second Bluetooth playing device separately.

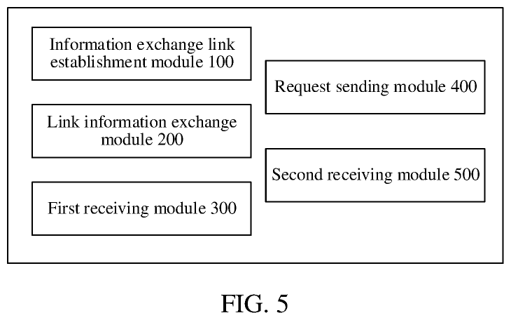

FIG. 5 is a schematic diagram of a structure of a packet loss data error correction apparatus in dual-transmit mode disclosed in an embodiment. The packet loss data error correction apparatus includes an information exchange link establishment module 100, a link information exchange module 200, a first receiving module 300, a request sending module 400, and a second receiving module 500.

The information exchange link establishment module 100 is configured to drive the first Bluetooth playing device to establish an information exchange link CTRL with the second Bluetooth playing device. The first Bluetooth playing device and the second Bluetooth playing device exchange communication information over the information exchange link CTRL.

The link information exchange module 200 is configured to control the first Bluetooth playing device to exchange link information with the second Bluetooth playing device over the information exchange link CTRL, so that the first Bluetooth playing device configures itself to listen on the second communication link CIS2 based on link information provided by the second Bluetooth playing device, and the second Bluetooth playing device configures itself to listen on the first communication link CIS1 based on link information provided by the first Bluetooth playing device.

The first receiving module 300 is configured to control, at a local link subevent anchor, the first Bluetooth playing device to receive first current audio data that is sent to the first Bluetooth playing device by the audio source device, where during the period, the second Bluetooth playing device listens to the first current audio data, and the local link subevent anchor is a time point at which the audio source device sends audio data to the first Bluetooth playing device over the first communication link CIS1.

The request sending module 400 is configured to: when the first current audio data is not received at the local link subevent anchor, control the first Bluetooth playing device to send, a preset time interval after the local link subevent anchor, a first forwarding request to the second Bluetooth playing device over the information exchange link CTRL, so that the second Bluetooth playing device forwards the first current audio data.

The second receiving module 500 is configured to control, at the arrival of an agreed anchor, the first Bluetooth playing device to receive the first current audio data that is forwarded by the second Bluetooth playing device based on the first forwarding request.

In an optional embodiment, the apparatus further includes:
a listening module, configured to control, at a listened-on link subevent anchor, the first Bluetooth playing device to listen to second current audio data that is sent to the second Bluetooth playing device by the audio source device, where the listened-on link subevent anchor is a time point at which the audio source device sends audio data to the second Bluetooth playing device over the second communication link CIS2; and
a window opening module, configured to control, a preset time interval after the listened-on link subevent anchor, the first Bluetooth playing device to open a receiving window for receiving a forwarding request, to receive, over the information exchange link CTRL, a second forwarding request that is sent by the second Bluetooth playing device, and forward the second current audio data to the second Bluetooth playing device based on the second forwarding request.

In an optional embodiment, in the window opening module, when the second forwarding request is received during the receiving window, the following is further included:
at the arrival of an agreed anchor, latching the first Bluetooth playing device into a forwarding state, and forwarding the second current audio data.

In an optional embodiment, in the window opening module, when the second forwarding request is not received during the receiving window, the following is further included:
controlling the first Bluetooth playing device to return to run the first receiving module or the listening module.

In an optional embodiment, the preset time interval is a sum of maximum duration of audio data currently sent by the audio source device and an interframe space between adjacent packets.

An embodiment further discloses a Bluetooth playing device. The Bluetooth playing device may be a device with wireless data exchange functionality such as Bluetooth earphones or Bluetooth speakers. The Bluetooth playing device includes a processor, configured to implement the method disclosed in the foregoing embodiment.

An embodiment further discloses an audio signal processing system, including a first Bluetooth playing device and a second Bluetooth playing device. The first Bluetooth playing device and the second Bluetooth playing device are an audio playing device pair, for example, a left and right earphone pair or a left and right speaker pair. In this embodiment, the first Bluetooth playing device has the apparatus disclosed in the foregoing embodiment, and the second Bluetooth playing device has the apparatus disclosed in the foregoing embodiment.

In an optional embodiment, the audio signal processing system further includes an audio source device. The audio source device is configured to provide audio data to the first Bluetooth playing device and the second Bluetooth playing device. The audio source device may be a device with a function of sending audio data over Bluetooth, such as a mobile phone, a tablet, a notebook computer, or a music player.

An embodiment further discloses a computer-readable storage medium. A computer program is stored in the computer-readable storage medium. The computer program stored in the storage medium is executed to implement the method disclosed in the foregoing embodiment.

An embodiment further discloses a chip for an audio device. An integrated circuit is provided on the chip. The integrated circuit is designed to implement the method disclosed in the foregoing embodiment.

According to the packet loss data error correction method and apparatus in dual-transmit mode, the device, and the system disclosed in the embodiments of the present invention, the first Bluetooth playing device exchanges link information with the second Bluetooth playing device over the information exchange link, so that the first Bluetooth playing device configures itself to listen on the second communication link based on link information provided by the second Bluetooth playing device, and the second Bluetooth playing device configures itself to listen on the first communication link based on link information provided by the first Bluetooth playing device. In this way, in dual-transmit mode, the first Bluetooth playing device and the second Bluetooth playing device can listen to audio data of each other. At the local link subevent anchor, the first Bluetooth playing device receives the first current audio data that is sent to the first Bluetooth playing device by the audio source device, where during the period, the second Bluetooth playing device listens to the first current audio data. In this way, the second Bluetooth playing device can also receive the audio data that is sent to the first Bluetooth playing device by the audio source device. When the first current audio data is not received at the local link subevent anchor, the first Bluetooth playing device sends the first forwarding request to the second Bluetooth playing device over the information exchange link the preset time interval after the local link subevent anchor. At the arrival of the agreed anchor, the first Bluetooth playing device receives the first current audio data that is forwarded by the second Bluetooth playing device based on the first forwarding request. In the embodiments of the present invention, in dual-transmit mode, when the first current audio data is not received, the first forwarding request is sent to the second Bluetooth playing device, and the first current audio data that is forwarded by the second Bluetooth playing device based on the first forwarding request is received. In this way, in dual-transmit mode, when data reception performance of the link of the first Bluetooth playing device deteriorates due to interference caused by factors such as environments and human bodies, the first current audio data can be forwarded by the second Bluetooth playing device. Because the first Bluetooth playing device and the second Bluetooth playing device are in different positions in space, a good space diversity gain can be obtained, reducing impact of poor signal quality that is caused by factors such as environments and human bodies. A manner of forwarding from another link is used to avoid a communication problem that is caused after a single link is interfered with, improving communication quality of dual Bluetooth playing devices.

It should be noted that using step numbers (letters or numbers) to represent some specific method steps in the present invention is merely for ease of description and brevity, rather than using letters or numbers to limit an order of these method steps. Persons skilled in the art can understand that an order of related method steps should be determined by the technology and should not be improperly limited due to presence of step numbers.

Persons skilled in the art can understand that the foregoing preferred solutions can be combined and superimposed freely if they do not conflict.

It should be understood that the foregoing implementations are merely illustrative but not restrictive. Without departing from basic principles of the present invention, any obvious or equivalent modifications or substitutions made by persons skilled in the art to the foregoing details shall be included in the scope of the claims of the present invention.

What is claimed is:

1. A packet loss data error correction method in dual-transmit mode, used for controlling data exchange between a first Bluetooth playing device (21) and a second Bluetooth playing device (22), wherein the first Bluetooth playing device (21), the second Bluetooth playing device (22), and an audio source device (20) constitute a Bluetooth communication network in dual-transmit mode; the audio source device (20) establishes a first communication link (CIS1) with the first Bluetooth playing device (21), and the audio source device (20) establishes a second communication link (CIS2) with the second Bluetooth playing device (22), so that the audio source device (20) performs audio data communication with the first Bluetooth playing device (21) and the second Bluetooth playing device (22) separately; and the packet loss data error correction method comprises:
step S100: driving the first Bluetooth playing device (21) to establish an information exchange link (CTRL) with the second Bluetooth playing device (22), wherein the first Bluetooth playing device (21) and the second Bluetooth playing device (22) exchange communication information over the information exchange link (CTRL);
step S200: controlling the first Bluetooth playing device (21) to exchange link information with the second Bluetooth playing device (22) over the information exchange link (CTRL), so that the first Bluetooth playing device (21) configures itself to listen on the second communication link (CIS2) based on link information provided by the second Bluetooth playing device (22), and the second Bluetooth playing device (22) configures itself to listen on the first communication link (CIS1) based on link information provided by the first Bluetooth playing device (21);
step S300: controlling, at a local link subevent anchor, the first Bluetooth playing device (21) to receive first current audio data that is sent to the first Bluetooth playing device (21) by the audio source device (20), wherein during the period, the second Bluetooth playing device (22) listens to the first current audio data, and the local link subevent anchor is a time point at which the audio source device (20) sends audio data to the first Bluetooth playing device (21) over the first communication link (CIS1);
step S400: when the first current audio data is not received at the local link subevent anchor, controlling the first Bluetooth playing device (21) to send, a preset time interval after the local link subevent anchor, a first forwarding request to the second Bluetooth playing device (22) over the information exchange link (CTRL), so that the second Bluetooth playing device (22) forwards the first current audio data; and
step S500: controlling, at the arrival of an agreed anchor, the first Bluetooth playing device (21) to receive the first current audio data that is forwarded by the second Bluetooth playing device (22) based on the first forwarding request.

2. The packet loss data error correction method in dual-transmit mode according to claim 1, further comprising:
step S320: controlling, at a listened-on link subevent anchor, the first Bluetooth playing device (21) to listen to second current audio data that is sent to the second Bluetooth playing device (22) by the audio source device (20), wherein the listened-on link subevent anchor is a time point at which the audio source device (20) sends audio data to the second Bluetooth playing device (22) over the second communication link (CIS2); and
step S420: controlling, a preset time interval after the listened-on link subevent anchor, the first Bluetooth playing device (21) to open a receiving window for receiving a forwarding request, to receive, over the information exchange link (CTRL), a second forwarding request that is sent by the second Bluetooth playing device (22), and forward the second current audio data to the second Bluetooth playing device (22) based on the second forwarding request.

3. The packet loss data error correction method in dual-transmit mode according to claim 2, wherein in step S420, when the second forwarding request is received during the receiving window, the method further comprises:
at the arrival of an agreed anchor, latching the first Bluetooth playing device (21) into a forwarding state, and forwarding the second current audio data.

4. The packet loss data error correction method in dual-transmit mode according to claim 2, wherein in step S420, when the second forwarding request is not received during the receiving window, the method further comprises:
controlling the first Bluetooth playing device (21) to return to perform step S300 or step S320.

5. The packet loss data error correction method in dual-transmit mode according to claim 1, wherein the preset time interval is a sum of maximum duration of audio data currently sent by the audio source device (20) and an interframe space between adjacent packets.

6. A packet loss data error correction apparatus in dual-transmit mode, configured to control data exchange between a first Bluetooth playing device (21) and a second Bluetooth playing device (22), wherein the first Bluetooth playing device (21), the second Bluetooth playing device (22), and an audio source device (20) constitute a Bluetooth communication network in dual-transmit mode; the audio source device (20) establishes a first communication link (CIS1) with the first Bluetooth playing device (21), and the audio source device (20) establishes a second communication link (CIS2) with the second Bluetooth playing device (22), so that the audio source device (20) performs audio data communication with the first Bluetooth playing device (21) and the second Bluetooth playing device (22) separately; and the packet loss data error correction apparatus comprises:
an information exchange link establishment module (100), configured to drive the first Bluetooth playing device (21) to establish an information exchange link (CTRL) with the second Bluetooth playing device (22), wherein the first Bluetooth playing device (21) and the second Bluetooth playing device (22) exchange communication information over the information exchange link (CTRL);
a link information exchange module (200), configured to control the first Bluetooth playing device (21) to exchange link information with the second Bluetooth playing device (22) over the information exchange link (CTRL), so that the first Bluetooth playing device (21) configures itself to listen on the second communication link (CIS2) based on link information provided by the second Bluetooth playing device (22), and the second Bluetooth playing device (22) configures itself to listen on the first communication link (CIS1) based on link information provided by the first Bluetooth playing device (21);
a first receiving module (300), configured to control, at a local link subevent anchor, the first Bluetooth playing device (21) to receive first current audio data that is sent to the first Bluetooth playing device (21) by the audio source device (20), wherein during the period, the second Bluetooth playing device (22) listens to the first current audio data, and the local link subevent anchor is a time point at which the audio source device (20) sends audio data to the first Bluetooth playing device (21) over the first communication link (CIS1);
a request sending module (400), configured to: when the first current audio data is not received at the local link subevent anchor, control the first Bluetooth playing device (21) to send, a preset time interval after the local link subevent anchor, a first forwarding request to the second Bluetooth playing device (22) over the information exchange link (CTRL), so that the second Bluetooth playing device (22) forwards the first current audio data; and
a second receiving module (500), configured to control, at the arrival of an agreed anchor, the first Bluetooth playing device (21) to receive the first current audio data that is forwarded by the second Bluetooth playing device (22) based on the first forwarding request.

7. The packet loss data error correction apparatus in dual-transmit mode according to claim 6, further comprising:
a listening module, configured to control, at a listened-on link subevent anchor, the first Bluetooth playing device (21) to listen to second current audio data that is sent to the second Bluetooth playing device (22) by the audio source device (20), wherein the listened-on link subevent anchor is a time point at which the audio source device (20) sends audio data to the second Bluetooth playing device (22) over the second communication link (CIS2); and
a window opening module, configured to control, a preset time interval after the listened-on link subevent anchor, the first Bluetooth playing device (21) to open a receiving window for receiving a forwarding request, to receive, over the information exchange link (CTRL), a second forwarding request that is sent by the second Bluetooth playing device (22), and forward the second current audio data to the second Bluetooth playing device (22) based on the second forwarding request.

8. The packet loss data error correction apparatus in dual-transmit mode according to claim 7, wherein in the window opening module, when the second forwarding request is received during the receiving window, the following is further comprised:
at the arrival of an agreed anchor, latching the first Bluetooth playing device (21) into a forwarding state, and forwarding the second current audio data.

9. The packet loss data error correction apparatus in dual-transmit mode according to claim 7, wherein in the window opening module, when the second forwarding request is not received during the receiving window, the following is further comprised:
controlling the first Bluetooth playing device (21) to return to run the first receiving module or the listening module.

10. The packet loss data error correction apparatus in dual-transmit mode according to claim 6, wherein the preset time interval is a sum of maximum duration of audio data currently sent by the audio source device (20) and an interframe space between adjacent packets.

11. A Bluetooth playing device, comprising:
a processor, configured to implement the method according to claim 1.

12. An audio signal processing system, comprising a first Bluetooth playing device (21) and a second Bluetooth playing device (22), wherein the first Bluetooth playing device (21) and the second Bluetooth playing device (22) are an audio playing device pair;
the first Bluetooth playing device (21) has the apparatus according to claim 6; and
the second Bluetooth playing device (22) has the apparatus according to claim 6.

13. The audio signal processing system according to claim 12, further comprising:
an audio source device (20), configured to provide audio data to the first Bluetooth playing device (21) and the second Bluetooth playing device (22).

14. A computer-readable storage medium, wherein a computer program is stored in the computer-readable storage medium, and the computer program stored in the storage medium is executed to implement the method according to claim 1.

15. A chip for an audio device, wherein an integrated circuit is provided on the chip, and the integrated circuit is designed to implement the method according to claim 1.
